(19) United States
(12) Patent Application Publication
(10) Pub. No.: US 2003/0061520 A1
(43) Pub. Date: Mar. 27, 2003

(54) Method and system to securely change a password in a distributed computing system

(76) Inventors: Mark H. Zellers, Mountain View, CA (US); William D. Goodwin, San Jose, CA (US); Mark A. Thompson, San Jose, CA (US)

Correspondence Address: Sawyer Law Group LLP, P O Box 51418, Palo Alto, CA, 94303, US

(21) Appl. No.: 09/960,845

(22) Filed: Sep. 21, 2001

(51) Int. Cl. H04L 9/32

(52) U.S. Cl. 713/202; 713/150

(57) ABSTRACT

Systems and methods to securely change a password in a distributed computing system are presented. According to an exemplary method, a stored value and a destination address of a user are stored. A request to change the password is received from the user. A message, for example, an electronic mail message, is sent to the destination address. The message specifies a link to the stored value. If the link is valid, then the user is permitted to log in to the distributed computing system using the stored value as a log in password. Each time that the user logs in to the distributed computing system, the stored value is updated, thereby invalidating any previously issued link.

### TECHNICAL FIELD

The present invention relates to computing networks and security, and, more particularly, to Internet security and secure password change methods.

### BACKGROUND

Increasingly, access to services on the World Wide Web (WWW; Web) and the Internet is granted via acceptance of a username and a password. For example, a user goes to a Web site and enters some amount of his or her personal information. The user chooses, or is given, a username and a password to access the site's services when, for example, the user returns to the site in the future. The username and the password provide the Web site with great assurance that the person being granted access is the person intended to be granted access. Meanwhile, the username and the password provide the user with a means to access services on a Web site. Typically, this access route to the Web site is secure so that the user has some great assurance that no unauthorized persons can access the Web site to impersonate the user or to view the user's personal information. If an unauthorized person should obtain the user's password, the user could become a victim of online fraud or at least suffer an invasion of his/her privacy.

Maintaining such a level of trust and assurance between the Web site service and the user is critical and is often paramount to the survival of the Web site service. If users cannot trust particular Web sites or the Internet in general to protect access to individualized, private information and services, the integrity of the system is at risk.

More generally, users of any distributing computing system typically need to use passwords to authenticate themselves for access to the system. Sometimes, however, a user needs to obtain access to the system but forgets his or her password. The administrators of the distributed computing system have mechanisms to inform the user of a new password or to remind the user of their old password.

Other systems do not store the user's password at all, but apply a hashing algorithm to the user's password at log-in and compare the hash value generated by the algorithm to a stored hash value in order to validate the password that the user entered. It is thus not possible for the system to send the user their current password directly. These systems must generate, and inform the user of, a new password.

Moreover, schemes for allowing a user to change their password that send the current password directly and immediately to the requesting user are susceptible to potential denial of service attacks from, for example, hackers or other intruders. A hacker might decide to change the passwords of users of a distributed computing system, thus preventing the users from logging in to the service.

Accordingly, it would be desirable to provide, in the event that a user has forgotten their password, an alternative verification scheme that does not suffer from the above-described drawbacks and weaknesses.

### SUMMARY

The presently preferred embodiments described herein include systems and methods for allowing a user of a distributed computing system to change his or her own password without allowing intruders to, for example, maliciously change the passwords of other users. The methods and systems described herein work in a distributed computing environment where a server system accepts requests from users that are authenticated by the use of passwords.

A method of securely changing a password in a distributed computing system is provided according to one aspect of the invention. According to the method, a stored value and a destination address of a user are stored. A request to change the password is received from the user. A message is sent to the destination address. The message specifies a link to the stored value. If the link is valid, then the user is permitted to log in to the distributed computing system using the stored value as a log in password. The stored value is updated each time that the user logs in to the distributed computing system.

A server in a distributed computing system to securely change a password is provided according to another aspect of the invention. The server includes a database, an interface, and an authentication engine. The interface is coupled to the database. The authentication engine coupled to the interface and the database. The database stores a stored value and a destination address of a user. The interface receives a request to change the password from the user and sends a message to the destination address. The message specifies a link to the stored value. The authentication engine is configured to update the stored value each time that the user logs in to the distributed computing system, and, if the link is valid, to permit the user to log in to the distributed computing system using the stored value as a log in password.

A method of securely changing a password in a distributed computing system is provided according to a further aspect of the invention. According to the method, a stored value and an electronic mail address of a user are stored. A request to change the password is received from the user. An electronic mail message is sent to the electronic mail address. The electronic mail message specifies a link to a secure World Wide Web page that displays the stored value. If the link is valid, then the user is permitted to log in to the distributed computing system using the stored value as a log in password. If the user successfully logs in with the stored value, then the user is prompted for a new password and the password is updated to the new password. The stored value is updated each time that the user logs in to the distributed computing system.

### BRIEF DESCRIPTION OF THE DRAWINGS

The foregoing and other features, aspects, and advantages will become more apparent from the following detailed description when read in conjunction with the following drawings, wherein:

FIG. 1 is a diagram illustrating the interaction of a user with an exemplary distributed computing system according to a presently preferred embodiment; and

FIG. 2 is a diagram illustrating an exemplary server according to the exemplary distributed computing system of FIG. 1.

### DETAILED DESCRIPTION OF THE PRESENTLY PREFERRED EMBODIMENTS

The present invention will now be described in detail with reference to the accompanying drawings, which are provided as illustrative examples of preferred embodiments of the present invention.

The presently preferred embodiments described herein include systems and methods for allowing a user of a distributed computing system to change his or her own password without allowing intruders to maliciously change the passwords of other users. The methods and systems described herein work in a distributed computing environment where a server system accepts requests from users that are authenticated by the use of passwords.

The systems and methods involve, for example, the use of the user's last login time and, for example, a destination address such as an e-mail address to authenticate the user for the purpose of changing their password. It is extremely unlikely that an intruder would know or could obtain knowledge of the exact last login time of a particular user. The exact last login time is preferably used to generate a one-time ticket to the system. Since logging in to the system automatically modifies the user's last login time, a successful login automatically invalidates the one-time ticket.

In a presently preferred embodiment, when a user indicates that they have forgotten their password, the system generates an e-mail containing the user's username and the time of their last login or some other value that is subject to change whenever the user logs in to the system. The information in the e-mail may be encrypted. For example, the e-mail could include a link to a secured Web page that included some sort of nonce, or one-time only, value, based on the last login time, for example—that would be known only to the system itself.

In a presently preferred embodiment, when the user submits this information and one-time value, or ticket, back to the system, the system randomly generates a new password and reveals that new password to the user. Once the user changes their password using this scheme, the one-time ticket will no longer be valid. Preferably, for added security, an expiration time accompanies, or is otherwise associated with, the ticket, such that the ticket would only be honored for a limited period of time.

In order for a malicious intruder to change a user's password, the intruder would need to be in a position to intercept the, for example, e-mail message from the system to the user. Since the user receives the ticket at a pre-registered address, it is unlikely that an intruder would be able to both request to change the password and be in a position to receive the ticket. In general, to maintain the integrity of the system, there preferably is an independent path, distinct from the path via which the user submits the password change request, to send the ticket to, such as a path to a pre-registered destination address.

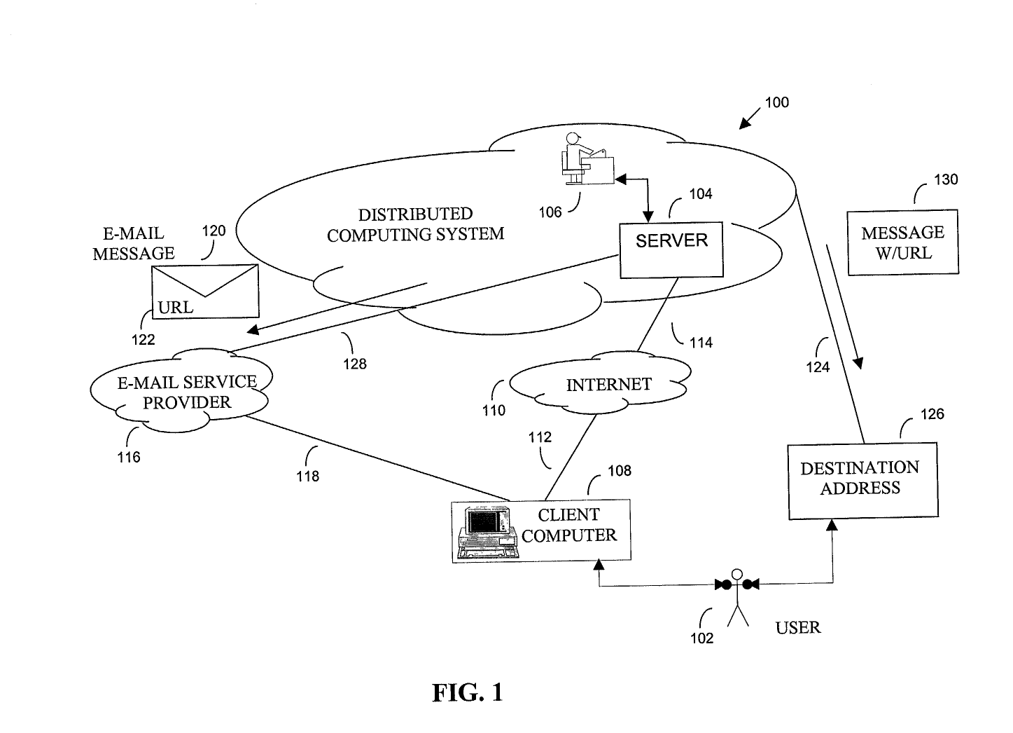

FIG. 1 is a diagram illustrating the interaction of a user 102 with an exemplary distributed computing system 100 according to a presently preferred embodiment. The system 100 includes a server 104 that further includes Web server functionality. An administrator 106 communicates with and has administrative privileges on the server 104. Although one server 104 is illustrated in FIG. 1, in general the system 100 may include any number of servers as suitable. Further, the server 104, and functions attributed to the server 104, could be understood to include any number of servers as suitable. Depending on the implementation, more than one server may be used as suitable in conjunction with server 104 to perform a password change operation for the user 102. The user 102 operates a client computer 108 and attempts to communicate with the distributed computing system 100 and the server 104 via the Internet 110 and links 112, 114. The user 102 preferably has an e-mail account with an e-mail service provider 116 and communicates with the e-mail service provider 116 over a link 118, via, for example, the Internet 110. The distributed computing system 100 and the server 104 communicate with, and send an e-mail message 120 to, the e-mail service provider over a link 128, via, for example, the Internet 110. The e-mail message 120 includes a specific link, for example, a URL 122, to a Web page that allows the user 102 to change her password in the event that, for example, she forgets her password, and as described below. This URL 122 is referred to as a password change URL 122 for purposes of explanation and description. Alternatively, and more generically, the exemplary distributed computing system 100 may send a message 130 to a destination address 126 of, and accessible to, the user 102 over a link 124. The message 130 similarly includes a specific link to a Web page, for example, a password change URL 122 that allows the user 102 to change her password as described below.

Of course, it should be understood that the networked configuration, connections, and communication links shown in FIG. 1 are merely intended to be exemplary, and that other configurations, connections and links are possible and may be used as suitable. For example, the user 102 and/or the client computer 108 may be members of the distributed computing system 100 and may communicate directly with the server 104, rather than via, for example, the Internet 110. The communication links may include intermediate networks or network devices, for example, the user 102 at client computer 108 may communicate with the e-mail service provider 116 via the Internet 110 or via the Internet 110 and a local telephone exchange, for example. As another example, the distributed computing system 100 preferably sends the e-mail message 120 that includes the URL 122 to the e-mail service provider 116 via the Internet 110 over the link 128. As discussed below, the link 124 between the distributed computing system 100 and the destination address 126 over which the message 130 with the URL 122 is sent can include any suitable means of, or medium of, communication and any suitable intervening communication devices or networks.

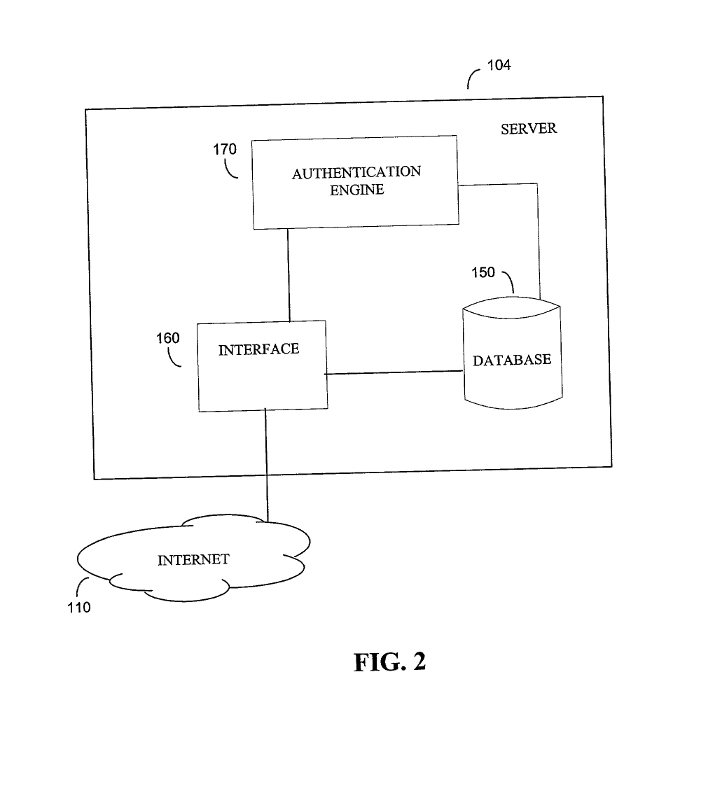

FIG. 2 is a diagram illustrating an exemplary server 104 according to the exemplary distributed computing system of FIG. 1. In addition to including Web server functionality, the exemplary server 104 includes a database 150, an interface 160, and an authentication engine 170. The database 150 preferably stores the most recent log in time of the user 102 as well as any destination addresses, for example an e-mail address obtained from the user 102 at the time of registration, for example. The database 150 preferably stores a hash value obtained from applying a hashing algorithm to the most recent log in time of the user 102. The interface 160 is coupled to the database 150 and the authentication engine 170 and is preferably configured to receive requests from clients such as the client computer 108 under the control of the user 102. When the interface 160 receives a password change request from the user 102, the interface 160 can send the message 130 to the destination address 126. The interface 160 can send the electronic mail message 120 to the e-mail service provider 116. The messages 120, 130 specify a link, such as the URL 122, to a Web page that takes as a parameter, the most recent log in time of the user 102 or the hash value thereof. The interface 160 is coupled to the Internet 110, preferably through a proxy server and/or a firewall at the distributed computing system 100. The authentication engine is coupled to the interface 160 and the database 150. The authentication engine preferably permits the user to log in to the distributed computing system using, for example, the hash value as a log in password and updates the hash value each time that the user 102 logs in to the distributed computing system 100.

Although the interface 160, the authentication engine 170, and the database 150 are grouped together as part of the exemplary server 104 of FIG. 2, any number of arrangements are possible. For example, the database 150 may be located externally from the server 104, and the authentication engine 170 may run on a separate server from the server 104. In a presently preferred embodiment, a first server performs the functions of the interface 160 and Web server functions and communicates with a second server that performs the functions of the authentication engine 170. In this embodiment, both the first server and the authentication engine 170 on the second server access a database 150 located separately therefrom, on a third server. According to this example, the server 104 is understood to include the first, second, and third servers.

According to a presently preferred embodiment, an exemplary method of securely changing a password in the distributed computing system 100 is now described. The user 102 is preferably registered with the system 100 as a user 102 with some level of access privileges. Information is obtained from the user 102, including a registration address, such as an e-mail address according to this example. The user 102 is assigned a userid or a username. The user 102 is preferably allowed to select a password to use to log in to the system 100. Each time that the user 102 logs in to the system 100, the authentication engine 170 takes note of the log in time. The database 150 stores the information obtained from the user 102 including the registration e-mail address. The database 150 also stores the most recent log in time of the user 102, obtained from the authentication engine 170. The most recent log in time of the user 102 is updated each time that the user 102 logs in to the system 100. The authentication engine 170 applies a hashing algorithm to the most recent long in time of the user 102 and stores a resulting hash value in the database 150. Of course, it should be understood that the authentication engine 170 could also lookup the most recent log in time of the user 102 if the user requests a password change, and, at that time, apply the hashing algorithm to the most recent log in time to obtain the hash value. That is, the system 100 could compute the hash value from the most recent log in time in the database 150 rather than store the hash value in the database 150.

According to an exemplary scenario where the user 102 forgets her password, the user 102 sends a request for a password via the client computer 108 or otherwise indicates to the system 100 that she has forgotten her password and requests a new password or a password change. When the system 100, for example the interface 160, receives the request or other indication, the authentication engine 170 preferably generates a message, according to this example the e-mail message 120, and the interface 160 sends the e-mail message 120 to the stored destination e-mail address at the e-mail service provider 116. The e-mail message 120 preferably includes a link, that is, the password change URL 122, to a Web page. The hash value of the most recent login time in effect at the time the hash value was generated is preferably incorporated into the URL 122. The interface 160 preferably creates a replica of the present stored hash value that is stored in the database 150 and incorporates the replica of the present stored hash value into the link, here the URL 122.

When the user 102 opens the e-mail message 120 and clicks on the URL 122, then the authentication engine 170 preferably compares the hash value from the URL 122 in the message 120 with the present stored hash value of the present last login time from the database 150. If the hash value matches the present stored hash value, then the authentication engine 170 preferably confirms that indeed this is a registered user 102 who has forgotten her password. The user 102 should be granted access back into the system 100. Therefore, the system 100, for example, the authentication engine 170, preferably accepts the URL 122 as valid and preferably allows the URL 122 to display a Web page, preferably a secure Web page, to the user 102.

Of course, it should be understood that the system 100 could incorporate the actual last login time into the URL 122 and then could perform a hashing algorithm on the login time in the URL 122 when the user 102 enters or clicks on the URL 122.

In a presently preferred embodiment, the Web page includes a message such as the following: “Welcome, your password has been changed successfully, here is your username, and your new password.” The Web page preferably includes a link or other URL at, for example, the bottom of the page, that asks the user 102 to log in with the username and the new password. The new password referred to here is preferably the nonce, or one-time only, ticket, that is, the temporary password. Preferably, the new password is the hash value or a password value uniquely associated with the hash value. Once the user 102 logs in to the system 100 using the new password, this act of logging in automatically updates the last or most recent login time and effectively invalidates the password change URL 122 to get back in the system 100. That is, the password change URL 122 includes, or incorporates, a hash value that is based on what is now the old last login time, and the hash value will not match the present stored hash value that was updated when the user 102 logged in with the one-time ticket password. Preferably, once logged in with the one-time ticket, the user 102 is steered in the direction of creating a new, more permanent, password that can be used any number of times as suitable. For example, in a presently preferred embodiment, the user 102 after logging in arrives at a Web page at which the user 102 can edit stored user 102 information so that the user 102 can easily change her password to, for example, a more personalized and easy to remember password. Of course, it should be understood that while it is preferable that the user select or create her own password, the system 100 could also, for example, generate a new password and reveal the new password to the user 102.

Any login will cause the last login time to be changed, and therefore that invalidates the URL 122 that the system 100 sent to the destination address 126 or e-mail address at e-mail service provider 116. If the user 102, for example, remembers her password after she requests the password change, she can log in using that password and by doing so, thus invalidate the password change URL 122. The selection of the last login time as the basis for granting access to the system in the event a user 102 forgets her password effectively creates a one-time ticket for entry into the system 100. Although in a presently preferred embodiment the most recent log in time of the user 102 is used as, or associated with, a one-time ticket to the system 100, any suitable value may be used. For example, the system 100 could generate a random value each time that the user 102 logs in to the system 100. This random value could serve as, or be associated with, the one-time ticket and be stored in the database 150.

In addition to the automatic invalidation of the password change URL 122 by the updating of the last login time, an expiration time is preferably associated with the password change URL 122, for example, when the message 120, 130 that contains the URL 122 is sent. The URL 122 is preferably expired when the expiration time is reached or elapses. The expiration time can be set in accordance with any suitable factors, such as the type of destination address 126 or e-mail address that is stored by the system and the type of message that includes or specifies the password change URL 122, for example. If the message is an electronic mail message 120, for example, the expiration time could be set for a short period of time such as ten or fifteen minutes, although of course any suitable time may be used for the expiration time. If the message 130 is a letter sent to a physical address, for example, the expiration time could be set for three days or even for a week or more. Of course, it should be understood that the system 100 need not specify or reveal the expiration time to the user 102.

If the user 102 attempts to log in to a Web site from home and forgets their password, an e-mail message is sent to the registered e-mail address. If the e-mail address is, for example, a work e-mail address, to which the user does not have immediate access, then the user 102 can request a password change the next day if, for example, the password change URL 122 in the previous e-mail message has expired.

Of course, the user 102 need not be seeking access to a Web site. Any distributed computing system such as system 100 where a user such as user 102 must be authenticated over a communications link may implement the password change systems and methods. For example, the distributed computing system could be a domain network and the user could be a registered user of the domain network. The domain network would store a destination address for the user that the user could access regardless of her access to the domain network, for example, a personal e-mail address. If the user forgets his or her password to the domain network, the domain network could send an e-mail to the personal e-mail address that would allow the user to contact a domain network Web site via a password change URL link. The user could use a password obtained at the domain network Web site as a one-time ticket into the domain network, at which point the user would preferably be required to select a new password. Users would preferably be asked to provide a destination address to which only they have access.

Of course, the message that includes or specifies the password change URL need not be an e-mail message and the destination address to which the message is sent need not be an e-mail address. Rather, any message 130 and destination address 126 combination may be used as suitable. Preferably, the destination address 126 is a pre-registered address associated with the user 102 requesting the password change. That is, the username or userid and the associated destination address are known to the distributed computing system 100 prior to the request for the password change. Preferably, the path from the distributed computing system to the destination address, and over which the message is sent, is a separate one from the path over which the user 102 requests a new password or informs the system that she has forgotten her password. For example, the message 130 can be an analog or digital communication that is sent to and received by a destination address device, such as, for example, a facsimile machine, a telephone or a cellular phone, or an alphanumeric pager. The message 130 could be, for example, a physical hard copy letter or article of mail sent to a destination address 126 that is a physical mailing address, such as a Post Office Box, or a residential or business address. The message could be a voice-synthesized telephone call. The effectiveness and validity of a particular mode of message 130 and destination address 126 that is used will in part depend on the duration of any expiration time associated with the password change URL 122. If the user 102 has registered a public key with the system, the message could be encrypted and the one-time ticket, or the link to one-time ticket, could be sent using public key encryption, which would further guarantee that only the intended recipient would be able to redeem the ticket.

Although the present invention has been particularly described with reference to the preferred embodiments, it should be readily apparent to those of ordinary skill in the art that changes and modifications in the form and details may be made without departing from the spirit and scope of the invention. It is intended that the appended claims include such changes and modifications.

What is claimed is:

1. A method of securely changing a password in a distributed computing system, comprising:
storing a stored value and a destination address of a user;
receiving a request to change the password from the user;
sending a message to the destination address, the message specifying a link to the stored value;
if the link is valid, then:
permitting the user to log in to the distributed computing system using the stored value as a log in password; and
updating the stored value each time that the user logs in to the distributed computing system.

2. The method according to claim 1, further comprising:
associating an expiration time with the link when the message is sent; and
invalidating the link when the expiration time is reached.

3. The method according to claim 2, further comprising:
automatically invalidating the link following log in by updating the stored value.

4. The method according to claim 3, further comprising:
receiving a public encryption key from the user; and
encrypting the message according to the public encryption key.

5. The method according to claim 4, further comprising:
if the user successfully logs in with the stored value, then:
prompting the user for a new password; and
updating the password to the new password.

6. The method according to claim 4, further comprising:
if the user successfully logs in with the stored value, then:
generating a new password;
updating the password to the new password; and
revealing the password to the user.

7. The method according to claim 5, further comprising:
registering the user to obtain the destination address.

8. The method according to claim 5, wherein the destination address is accessed separately from an entity that the user uses to log in to the distributed computing system.

9. The method according to claim 5, further comprising:
for any link, permitting the user to log in using the stored value only one time

10. The method according to claim 9, wherein the stored value comprises the last login time of the user.

11. The method according to claim 9, further comprising:
applying a hashing algorithm to a most recent log in time of the user to generate the stored value.

12. The method according to claim 9, further comprising:
creating a replica of the stored value;
incorporating the replica into the link;
comparing the replica with the stored value to determine whether the link is valid.

13. The method according to claim 9, further comprising:
incorporating a log in time of the user into the link;
applying a hashing algorithm to the log in time value to generate a hash value;
comparing the hash value with the stored value to determine whether the link is valid.

14. The method according to claim 1, wherein the link to the stored value is a URL to a secure World Wide Web page that displays the stored value.

15. The method according to claim 1, wherein the message comprises an electronic mail message and the destination address comprises an electronic mail address.

16. The method according to claim 1, wherein the message comprises a hard copy mailing and the destination address comprises a physical mail delivery address.

17. The method according to claim 1, wherein the message comprises a digital communication and the destination address comprises an alphanumeric pager.

18. The method according to claim 1, wherein the message comprises a voice-synthesized telephone call and the destination address comprises a telephone.

19. The method according to claim 1, wherein the message comprises a digital communication and the destination address comprises a facsimile machine.

20. The method according to claim 1, wherein the message includes a username of the user.

21. A server in a distributed computing system to securely change a password, the server comprising:
a database to store a stored value and a destination address of a user;
an interface coupled to the database to receive a request to change the password from the user and to send a message to the destination address, the message specifying a link to the stored value; and
an authentication engine coupled to the interface and the database, the authentication engine configured to update the stored value each time that the user logs in to the distributed computing system, and, if the link is valid, to permit the user to log in to the distributed computing system using the stored value as a log in password.

22. The server according to claim 21, wherein the authentication engine associates an expiration time with the link when the message is sent so that the link is no longer valid when the expiration time is reached.

23. The server according to claim 22, wherein the authentication engine automatically invalidates the link by updating the stored value each time that the user logs in to the distributed computing system.

24. The server according to claim 23, wherein the server receives a public encryption key from the user and encrypts the message according to the public encryption key.

25. The server according to claim 24, wherein for any link, the authentication engine permits the user to log in using the stored value only one time.

26. The server according to claim 25, wherein the authentication engine applies a hashing algorithm to a most recent log in time of the user to generate the stored value.

27. The server according to claim 25, wherein the authentication engine creates a replica of the stored value, incorporates the replica into the link, and compares the replica with the stored value to determine whether the link is valid when a user attempts to log in to the distributed computing system.

28. The server according to claim 25, wherein the authentication engine incorporates a log in time of the user into the link, applies a hashing algorithm to the log in time value to generate a hash value, and compares the hash value with the stored value to determine whether the link is valid when a user attempts to log in to the distributed computing system.

29. A distributed computing system to securely change a password, the distributed computing system in communication with the Internet, comprising:
means for storing a stored value and a destination address of a user;
means for receiving a request to change the password from the user;
means for sending a message to the destination address, the message specifying a link to the stored value;
means for permitting the user to log in to the distributed computing system using the stored value as a log in password if the link is valid; and
means for updating the stored value each time that the user logs in to the distributed computing system.

30. A method of securely changing a password in a distributed computing system, comprising:
storing a stored value and an electronic mail address of a user;
receiving a request to change the password from the user;
sending an electronic mail message to the electronic mail address, the electronic mail message specifying a link to a secure World Wide Web page that displays the stored value;
if the link is valid, then:
permitting the user to log in to the distributed computing system using the stored value as a log in password; and
if the user successfully logs in with the stored value, then:
prompting the user for a new password; and
updating the password to the new password; and
updating the stored value each time that the user logs in to the distributed computing system.

31. The method according to claim 25, further comprising:
associating an expiration time with the link when the message is sent; and
expiring the link when the expiration time is reached.

32. The method according to claim 26, further comprising:
automatically expiring the link following log in by updating the stored value.
